(19) United States
(12) Patent Application Publication
(10) Pub. No.: US 2009/0272726 A1
(43) Pub. Date: Nov. 5, 2009

(54) Method for Manufacturing Display Apparatus and Manufacturing Apparatus of the Display Apparatus

(75) Inventors: Atsuo Nozaki, Tokyo (JP); Shigeyoshi Otsuki, Kanagawa (JP)

Correspondence Address: FLYNN THIEL BOUTELL & TANIS, P.C., 2026 RAMBLING ROAD, KALAMAZOO, MI, 49008-1631, US

(73) Assignees: KURARAY CO., LTD., Kurashiki-shi (JP); JSR CORPORATION, Tokyo (JP); SUMITOMO CHEMICAL COMPANY, LIMITED, Tokyo (JP); SUMITOMO BAKELITE Co., Ltd., Tokyo (JP); DAI NIPPON PRINTING CO., LTD., Tokyo (JP); TOPPAN PRINTING CO., LTD., Tokyo (JP); NEC Corporation, Tokyo (JP); HITACHI CHEMICAL CO., LTD., Tokyo (JP)

(21) Appl. No.: 12/309,556

(22) PCT Filed: Jul. 31, 2006
(86) PCT No.: PCT/JP2006/315175

§ 371 Date: Jan. 20, 2009

(30) Foreign Application Priority Data
Jul. 24, 2006 (JP) 2006-200277

(51) Int. Cl. B23K 26/38; B23K 26/40

(52) U.S. Cl. 219/121.72; 219/121.67; 438/30

(57) ABSTRACT

[PROBLEM] A thin film laminated substrate is cut by a laser beam under certain conditions, so that a cut surface which is sufficient for a display apparatus can be obtained without damaging the thin film laminated substrate, and the cutting is enabled by a low-output inexpensive apparatus, so that a reduction in cost can be expected.

[Solving Means] In a display apparatus manufacturing method for emitting a laser beam 43 to the thin film laminate substrate 1 to be used for the display apparatus so as to cut the thin film laminated substrate 1, machining conditions of the laser beam are such that an output of the laser beam is 12 to 18 W, a cutting speed of the laser beam is 130 to 170 mm/sec. and the number of repetitive emitting times of the laser beam is 10 to 15 times, and the laser beam 43 is emitted from at least one surface of the thin film laminated substrate 1 so that the thin film laminated substrate 1 is cut.

### TECHNICAL FIELD

The present invention relates to a display apparatus manufacturing method for emitting a laser beam to a thin film laminated substrate to be used for the display apparatus so as to cut the thin film laminated substrate, and a manufacturing apparatus of the display apparatus.

### BACKGROUND ART

In some thin film laminated substrates to be used for a display apparatus, substrates are stuck to each other via sealant and liquid crystal, and the stuck substrate is cut (for example, see Patent Document 1). Normally, in the case of cutting a glass substrate, a method for combining two steps of scribing (scratching) and breaking (beating in) and cutting the substrate into a predetermined size is known (for example, see Patent Document 2).

On the other hand, in recent years, particularly in mobile display apparatuses, panels should be thin, light and further bent as application to curved surface displays, and a panelized state of resin substrates is examined. In the case of cutting resin films, a method for cutting the resin films into a predetermined size using a blade such as a cutter blade or a Thompson blade is generally used. However, in the case of TFT substrates, very high heat resistance property is required due to a process for fabricating TFT, and since heat-resistant resin substrates which are equivalent to glass substrates are not present, the glass substrates are used.

Further, in order to repress the use of back light during daylight by providing an additional function such as a reflective film so as to contribute to electric power saving, a resin substrate on which a reflective metal film is formed in advance is occasionally stuck to a TFT glass substrate. The resin substrate in this case also requires high heat-resistant property and a linear expansion coefficient close to that of the glass substrate due to the process, and thus a reinforced composite material into which glass fiber is kneaded is occasionally used.

### Patent Document 1: Japanese Patent Publication No. 3206116

### Patent Document 2: Japanese Patent Application Laid-Open No. 9-309736

### DISCLOSURE OF THE INVENTION

### Problem to be Solved by the Invention

When a composite substrate made by glass and resin is cut by scribe, break and a blade, glass fiber debris is exposed from a cut surface so as to fly to a periphery, or glass get chipped or is broken. As a result, it is difficult to cut the composite substrate. Further, in some cases, a substrate is cut by emitting a laser beam as general industrial use, but after a reflective metal film is laminated to be stuck to a resin substrate, the laminated substrate is stuck to a glass substrate thinned by etching so that a thin film laminated substrate has flexibility. The thin film laminated substrate is cut into any size so as to be panelized, but this substrate is expensive and the cost rises.

The present invention is devised in view of such a circumstance, and its object is to provide a display apparatus manufacturing method for cutting a thin film laminated substrate using a laser beam under certain conditions and obtaining a cut surface which is sufficient as the display apparatus without damaging the thin film laminated substrate and enables the cutting by means of an low-output inexpensive apparatus so as to be capable of expecting a reduction in cost, and a manufacturing method of the display apparatus.

### Means to Solve the Problem

In order to solve the above problem, the present invention has the following constitution.

The invention according to claim 1 is a display apparatus manufacturing method for emitting a laser beam to a thin film laminated substrate to be used for a display apparatus so as to cut the thin film laminated substrate, characterized in that machining conditions of the laser beam are such that an output of the laser beam is 12 to 18 W, a cutting speed of the laser beam is 130 to 170 mm/sec. and the number of repetitive emitting times of the laser beam is 10 to 15 times, and the laser beam is emitted from at least one surface of the thin film laminated substrate so that the thin film laminated substrate is cut.

The invention according to claim 2 is the display apparatus manufacturing method according to claim 1, characterized in that the laser beam is a CO₂ laser beam.

The invention according to claim 3 is the display apparatus manufacturing method according to claim 1 or 2, characterized in that the thin film laminated substrate has a glass substrate and a resin substrate.

The invention according to claim 4 is the display apparatus manufacturing method according to any one of claims 1 to 3, characterized in that the thin film laminated substrate has a reflective metal film.

The invention according to claim 5 is the display apparatus manufacturing method according to any one of claims 1 to 4, characterized in that a thickness t of the thin film laminated substrate is 0.1 mm=t=0.3 mm.

The invention according to claim 6 is the display apparatus manufacturing method according to any one of claims 1 to 5, characterized in that the thin film laminated substrate has a roll shape.

The invention according to claim 7 is a manufacturing apparatus of a display apparatus, characterized by comprising: a winding-off section which winds off a roll-shaped thin film laminated substrate to be used for a display apparatus; a winding-up section which winds up an unnecessary portion of the cut-out thin film laminated substrate; and a laser machining apparatus which emits a laser beam for cutting out the thin film laminated substrate, wherein machining conditions of the laser beam are such that an output of the laser beam is 12 to 18 W, a cutting speed of the laser beam is 130 to 170 mm/sec. and the number of repetitive emitting times of the laser beam is 10 to 15 times, and the laser beam is emitted from at least one surface of the thin film laminated substrate so that the thin film laminated substrate is cut.

The invention according to claim 8 is the manufacturing apparatus of the display apparatus according to claim 7, characterized in that the laser beam is a CO₂ laser beam.

### EFFECT OF THE INVENTION

Due to the above constitution, the invention has the following effects.

In the invention according to claims 1 and 7, the thin film laminated substrate is cut by emitting a laser beam from at least one surface of the thin film laminated substrate under certain conditions, so that the cut surface which is sufficient for the display apparatus can be obtained without damaging the thin film laminated substrate. Further, since the cutting is enabled by the low-output inexpensive apparatus, the reduction in cost can be expected.

In the invention according to claims 2 and 7, the laser beam is the CO₂ laser beam, and the low-output inexpensive apparatus can continuously oscillate the laser beam.

In the invention according to claim 3, the thin film laminated substrate has the glass substrate and the resin substrate, and can be used widely as the substrate of the display apparatus.

In the invention according to claim 4, the thin film laminated substrate has the reflective metal film, and can be used widely as the substrate of the display apparatus.

In the invention according to claim 5, the thickness t of the thin film laminated substrate is 0.1 mm=t=0.3 mm, and can be used widely as the substrate of the thin type display apparatus.

In the invention according to claim 6, the thin film laminated substrate has the roll shape, and an unnecessary portion of the cut-out thin film laminated substrate is wound up, so that the thin film laminated substrate is cut out. As a result, the substrate of the display apparatus can be manufactured efficiently.

### BEST MODE FOR CARRYING OUT THE INVENTION

A method for manufacturing a display apparatus and a manufacturing apparatus of the display apparatus according to embodiments of the present invention is described in detail below with reference to the drawings. The embodiment of the present invention is the best mode of the present invention, and the present invention is not limited to this.

A first embodiment is described with reference to FIGS. 1 to 4. FIG. 1 is a conceptual diagram illustrating a constitution of a thin film laminated substrate, FIG. 2 is a schematic constitutional diagram of the manufacturing apparatus of the display apparatus, FIG. 3 is a plan view illustrating laser cutting of the thin film laminated substrate, and FIG. 4 is a diagram illustrating a state that the cut-out thin film laminated substrates are stick to each other.

The thin film laminated substrate 1 to be used in the display apparatus of the present invention is, as shown in FIG. 1, formed by laminating a diffusion reflection foundation layer 11, reflective metal layer 12, an adhesive layer 13 and a glass substrate 14 in this order on a resin substrate 10. The thin film laminated substrate 1 has the resin substrate 10 and the glass substrate 14 on its both sides, and has the reflection metal layer 12 on a middle portion. A thickness t of the thin film laminated substrate 1 is 0.1 mm=t=0.3 mm. When the thickness t of the thin film laminated substrate 1 is too thin, production treatment becomes problem, and when the thickness is too thick, the display apparatus becomes large. The thickness is set to the prescribed thickness t, so that the thin film laminated substrate can be widely used as the substrate of the thin display apparatus.

The method for manufacturing the display apparatus and the manufacturing apparatus of the display apparatus of the present invention are described with reference to FIGS. 2 to 4. The manufacturing apparatus of the display apparatus according to the embodiment has, as shown in FIG. 2, a winding-off section 20 which winds off the roll-shaped thin film laminated substrate 1 to be used for the display apparatus, a winding-up section 30 which winds up an unnecessary portion of the cut-out thin film laminated substrate 1, and a laser machining apparatus 40 which emits a laser beam for cutting out the thin film laminated substrate 1. A front-stage guide roller 50 is disposed at a front stage of the laser machining apparatus 40, and a rear-stage guide roller 51 is disposed at a rear stage. The front-stage guide roller 50 and the rear-stage guide roller 51 enable the thin film laminated substrate 1 to be carried in a horizontal direction with planarity being maintained.

The laser machining apparatus 40 has a supporting plate 41 and a laser oscillator 42, and the laser oscillator 42 emits a laser beam 43 from at least one surface of the thin film laminated substrate 1 via an optical system so that the substrate 1 is cut. In this embodiment, the laser beam 43 is emitted from the side of the glass substrate 14 of the thin film laminated substrate 1 so that the substrate 1 is cut, but the laser beam 43 may be emitted from the side of the resin substrate so that the substrate 1 is cut.

A continuous oscillation laser is preferable as the laser oscillator 42, and any one laser is selected from Ar laser, Kr laser, CO₂ laser, YAG laser, YVO₄ laser, forsterite (Mg₂SiO₄) laser, YLF laser, YAlO₃ laser, GdVO₄ laser, Y₂O₃ laser, ruby laser, alexandrite laser, Ti: sapphire laser, helium-cadmium laser, and laser whose medium is obtained by adding one kind or plural kinds of Nd, Yb, Cr, Ti, Ho, Er, Tm and Ta as dopant to polycrystalline (ceramic) YAG, Y₂O₃, YVO₄, YAlO₃ or GdVO₄.

Also a pulse oscillation laser can be used, and any one layer is selected from Ar laser, Kr laser, excimer laser, CO₂ laser, YAG laser, Y₂O₃ laser, YVO₄ laser, forsterite (Mg₂SiO₄) laser, YLF laser, YAlO₃ laser, GdVO₄ laser, glass laser, ruby laser, alexandrite laser, Ti: sapphire laser, copper vapor laser, gold vapor laser beam, and a laser whose medium is obtained by adding one kind or plural kinds of Nd, Yb, Cr, Ti, Ho, Er, Tm and Ta as dopant to polycrystalline (ceramic) YAG, Y₂O₃, YVO₄, YAlO₃ or GdVO₄.

The optical system includes a beam expander, a beam homogenizer, a cylindrical lens or the like. Since the laser oscillator occasionally includes a lens, in this case, the laser oscillator is included in the optical system.

In this embodiment, the CO₂ laser oscillator is used, so that the apparatus can continuously oscillate a low-output laser beam and can be inexpensive.

Machining conditions of the laser beam are such that an output of the laser beam is 12 to 18 W, a cutting speed of the laser beam is 130 to 170 mm/sec., and the number of repetitive emitting times of the laser beam is 10 to 15 times.

The laser beam 43 is emitted from at least one surface of the thin film laminated substrate 1 under such machining conditions of the laser beam 43, and as shown in FIG. 3, the thin film laminated substrate 1 is cut out so that the cut-out thin film laminated substrate 1a is obtained. The cut-out thin film laminated substrate 1a has a square shape when viewed from a plane, and in this case the laser oscillator 42 is moved and the thin film laminated substrate 1 is cut into the square shape viewed from the plane, or a direction of the laser beam 43 is changed so that the substrate 1 is cut into a square shape viewed from a plane by the optical system of the laser oscillator 42.

The cut-out thin film laminated substrate 1a is, as shown in FIG. 4, used for manufacturing the display apparatus of a liquid crystal display panel, and the liquid crystal display panel is continuously manufactured by using a long flexible plastic film 1b. In this case, the thin film laminated substrate 1a is stuck to the flexible plastic film 1b via liquid crystal, and thereafter, the flexible plastic film 1b is cut.

The thin film laminated substrate 1 is cut under the machining conditions of the laser beam 43, so that a cut surface 1a1 which is sufficient for the display apparatus can be obtained without damaging the cut-out thin film laminated substrate 1a, and since the cutting is enabled by the low-output inexpensive apparatus, the reduction in cost can be expected.

The thin film laminated substrate 1 has a roll shape and is cut out and an unnecessary portion is wound up, so that the thin film laminated substrate 1 is cut out and the substrate of the display apparatus can be manufactured efficiently.

An example of the present invention is described below.

### EXAMPLE

A diffusion foundation layer was continuously formed on a roll-shaped glass fiber mixed transparent resin substrate with thickness of 0.12 mm and width of 300 mm, so that a reflective metal film was laminated by sputtering.

A glass substrate with thickness of 0.1 mm and width of 300 mm which was thinned by etching was stuck to a resin substrate formed with the reflective metal film via adhesive agent, so that a member of the thin film laminated substrate was manufactured.

A plurality of pieces of 40 mm×45 mm was cut from the member of the stuck thin film laminated substrate by a laser machining apparatus (V: L-200 made by Universal Laser) under combinations of various conditions, and they were evaluated.

When the laser output was 10 to 20 W, the cutting speed was to 200 mm/sec. and the number of repetitive emitting times was 8 to 18 times, the cut-out thin film laminated substrate obtained a satisfactory cut surface within the following range.

When the laser output was 12 to 18 W, the cutting speed was 130 to 170 mm/sec. and the number of repetitive emitting times was 10 to 15 times, as the evaluation, it was visually ensured that the cut surface had no glass cracking or chipping, and it could be ensured by observation using a loupe that the satisfactory cut surface which had no fine chipping and glass fiber debris could be obtained.

Further, glass cracking or chipping occurred under conditions other than the above laser machining conditions. The panel of the display apparatus was manufactured from the pieces having the satisfactory cut surface, and it was ensured that the panel operated satisfactorily.

### INDUSTRIAL APPLICABILITY

The present invention can be applied to the display apparatus manufacturing method for emitting a laser beam to the thin film laminated substrate to be used for the display apparatus so as to cut the thin film laminated substrate, and the manufacturing apparatus of the display apparatus. The thin film laminated substrate is cut by the laser beam under certain conditions. As a result, the cut surface which is sufficient as the display apparatus can be obtained without damaging the thin film laminated substrate, and the cutting is enabled by the low-output inexpensive apparatus, so that the reduction in cost can be expected.

### BRIEF DESCRIPTION OF THE DRAWINGS

FIG. 1 is a conceptual diagram illustrating a constitution of a thin film laminated substrate.

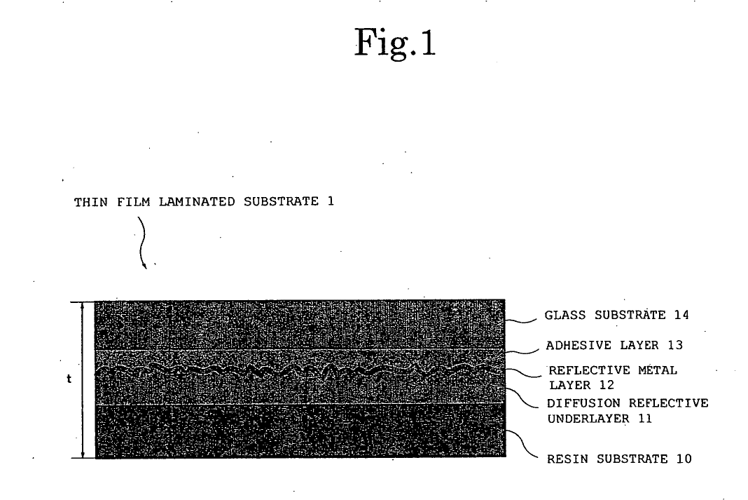

FIG. 2 is a schematic constitutional diagram illustrating a manufacturing apparatus of a display apparatus.

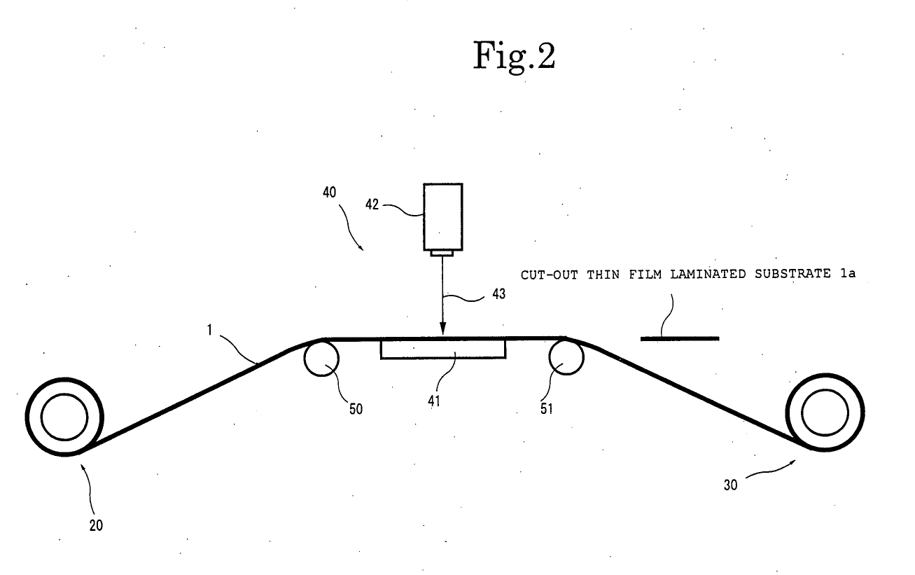

FIG. 3 is a plan view illustrating laser cutting of the thin film laminated substrate.

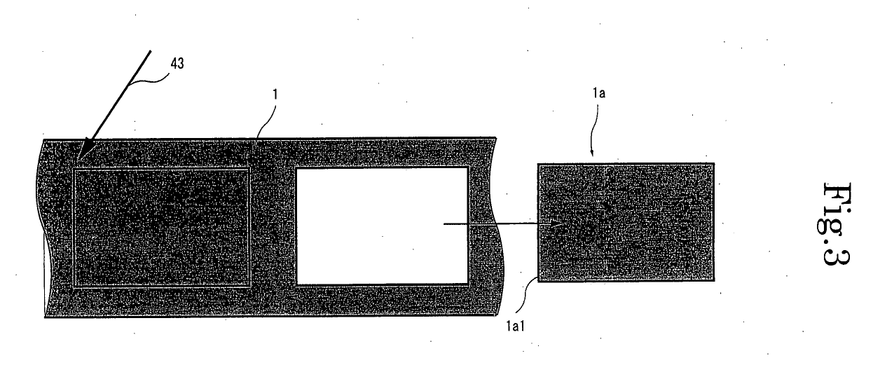

FIG. 4 is a diagram illustrating a state that cut-out thin film laminated substrates are stuck to each other.

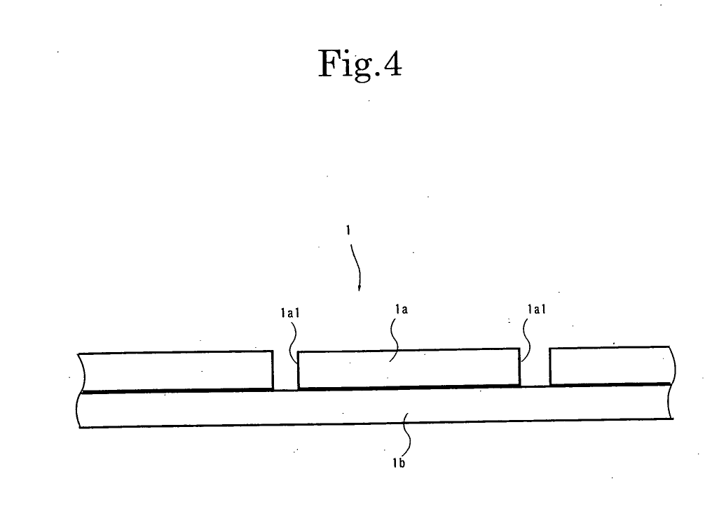

### DESCRIPTION OF REFERENCE NUMERALS

1 thin film laminated substrate

1a cut-out thin film laminated substrate

1a1 cut surface

1b flexible plastic film

10 resin substrate

11 diffusion reflective underlayer

12 reflective metal layer

13 adhesive layer

14 glass substrate

20 winding-off section

30 winding-up section

40 laser machining apparatus

41 supporting plate

42 laser oscillator

43 laser beam

50 front-stage guide roller

51 rear-stage guide roller

1. A display apparatus manufacturing method for emitting a laser beam to a thin film laminated substrate to be used for a display apparatus so as to cut the thin film laminated substrate, characterized in that machining conditions of the laser beam are such that an output of the laser beam is 12 to 18 W, a cutting speed of the laser beam is 130 to 170 mm/sec. and the number of repetitive emitting times of the laser beam is 10 to 15 times, and the laser beam is emitted from at least one surface of the thin film laminated substrate so that the thin film laminated substrate is cut.

2. The display apparatus manufacturing method according to claim 1, characterized in that the laser beam is a CO₂ laser beam.

3. The display apparatus manufacturing method according to claim 1, characterized in that the thin film laminated substrate has a glass substrate and a resin substrate.

4. The display apparatus manufacturing method according to claim 1, characterized in that the thin film laminated substrate has a reflective metal film.

5. The display apparatus manufacturing method according to claim 1, characterized in that a thickness t of the thin film laminated substrate is 0.1 mm=t=0.3 mm.

6. The display apparatus manufacturing method according to claim 1, characterized in that the thin film laminated substrate has a roll shape.

7. A manufacturing apparatus of a display apparatus, characterized by comprising:
a winding-off section which winds off a roll-shaped thin film laminated substrate to be used for a display apparatus;
a winding-up section which winds up an unnecessary portion of the cut-out thin film laminated substrate; and
a laser machining apparatus which emits a laser beam for cutting out the thin film laminated substrate,
wherein machining conditions of the laser beam are such that an output of the laser beam is 12 to 18 W, a cutting speed of the laser beam is 130 to 170 mm/sec. and the number of repetitive emitting times of the laser beam is 10 to 15 times, and the laser beam is emitted from at least one surface of the thin film laminated substrate so that the thin film laminated substrate is cut.

8. The manufacturing apparatus of the display apparatus according to claim 7, characterized in that the laser beam is a CO₂ laser beam.
